(19) United States
(12) Patent Application Publication
(10) Pub. No.: US 2010/0164605 A1
(43) Pub. Date: Jul. 1, 2010

(54) SEMICONDUCTOR INTEGRATED CIRCUIT

(76) Inventors: Jun-Ho LEE, Gyeonggi-do (KR); Hyung-Dong Lee, Gyeonggi-do (KR); Hyun-Seok Kim, Gyeonggi-do (KR)

Correspondence Address: IP & T Law Firm PLC, 7700 Little River Turnpike, Suite 207, Annandale, VA, 22003, US

(21) Appl. No.: 12/650,592

(22) Filed: Dec. 31, 2009

(30) Foreign Application Priority Data
Dec. 31, 2008 (KR) 10-2008-0138573

(51) Int. Cl. G05F 1/10

(52) U.S. Cl. 327/530

(57) ABSTRACT

A semiconductor integrated circuit is capable of minimizing/decreasing the increase in the inductance of a package due to a power supply network thereof. The semiconductor integrated circuit includes a first power mesh configured to supply a first power to a first internal circuit, a second power mesh configured to supply a second power to a second internal circuit, the first power and the second power being used for different purposes and being equal in DC level, and a connection unit configured to connect the first power mesh to the second power mesh.

### CROSS-REFERENCE TO RELATED APPLICATIONS

The present application claims priority of Korean Patent Application No. 10-2008-0138573, filed on Dec. 31, 2008, which is incorporated herein by reference in its entirety.

### BACKGROUND OF THE INVENTION

Exemplary embodiments of the present invention relate to a semiconductor integrated circuit design technology, and more particularly, to a power mesh routing for a power supply voltage and a ground voltage.

Semiconductor devices such as semiconductor integrated circuits are supplied with external power supply voltages and ground voltages for their operations.

In order to support various functions of semiconductor integrated circuits and ensure operation reliabilities of semiconductor integrated circuits, various power supply voltages and ground voltages are applied through separate pins, even if their voltage levels are the same.

For example, in addition to the typical power supply voltage VDD and ground voltage VSS, a power supply voltage (VDDQ) and a ground voltage (VSSQ) dedicated to an output driver may be used. In case of semiconductor integrated circuits using a delay locked loop (DLL), a power supply voltage (VDDL) and a ground voltage (VSSDL) dedicated to the DLL may be used.

Meanwhile, the power supply voltage pads or the ground voltage pads of the same type are mutually connected to each other through their power meshes (for example, metal interconnections). Thus, stable power may be supplied to all internal circuits of semiconductor integrated circuits, while reducing the resistance of power supply networks.

In the case of a conventional semiconductor integrated circuit, power-ground networks for the external power supply voltage and ground voltage may be separated into several pairs. For example, power-ground networks may be separated into power-ground networks for signal input/output, power-ground networks for driving internal memory circuits, power-ground networks for internal clock circuits, etc. The power meshes are routed within the semiconductor integrated circuit to implement the separated power-ground networks.

When power-ground networks are designed to be separated from one another based on usage, power noise may be isolated between the power-ground networks. However, the package inductance may increase and thus cause an accompanying increase in high-frequency noise. Further, it may be difficult to design the metal interconnections for implementing the separate power-ground networks, i.e., the power mesh routing, to be separated within the semiconductor integrated circuit.

### SUMMARY OF THE INVENTION

An embodiment of the present invention is directed to a semiconductor integrated circuit, which is capable of minimizing/reducing the increase in the inductance of a package due to a power supply network thereof.

In accordance with an embodiment of the present invention, a semiconductor integrated circuit includes a first power mesh configured to supply a first power to a first internal circuit, a second power mesh configured to supply a second power to a second internal circuit, the first power and the second power being used for different purposes and being equal in DC level, and a connection unit configured to connect the first power mesh to the second power mesh.

In accordance with another embodiment of the present invention, a semiconductor integrated circuit includes a first power mesh configured to supply a first external power voltage to a first internal circuit, and a second power mesh configured to supply a second external power supply voltage to a second internal circuit, wherein the first external power supply voltage and the second external power supply voltage are used for different purposes and are equal in DC level, and the first power mesh and the second power mesh are electrically connected to each other.

In accordance with still another embodiment of the present invention, a semiconductor integrated circuit includes a first power mesh configured to supply a first ground voltage to a first internal circuit, and a second power mesh configured to supply a second ground voltage to a second internal circuit, wherein the first ground voltage and the second ground voltage are used for different purposes, and the first power mesh and the second power mesh are electrically connected to each other.

### BRIEF DESCRIPTION OF THE DRAWINGS

FIG. 1 is a circuit diagram explaining a power mesh routing of a semiconductor integrated circuit in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

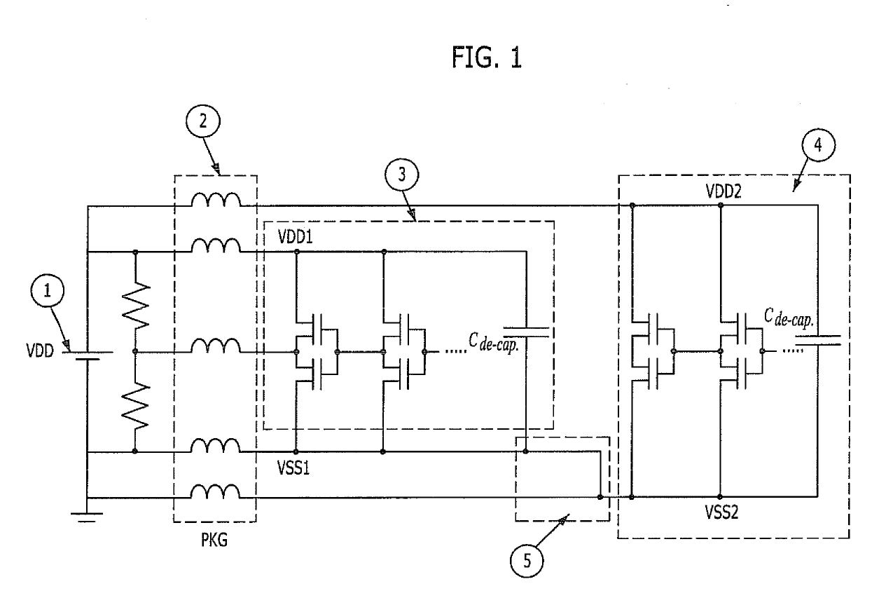

FIG. 1 is a circuit diagram illustrating a power mesh routing of a semiconductor integrated circuit in accordance with an embodiment of the present invention.

In FIG. 1, reference numeral 1 denotes an external power supply, and reference numeral 2 denotes a modeling of a package (PKG) inductance. Reference numerals 3 and 4 denote a VDD1-VSS1 power supply network and a VDD2-VSS2 power supply network, respectively. Reference numeral 5 denotes a VSS1-VSS2 metal interconnection.

Capacitors C_{de-cap} connected between VDD1 and VSS1 and between VDD2 and VSS2 are decoupling capacitors. The capacitors C_{de-cap} separate the semiconductor integrated circuit from noise generated from the external power supply 1.

Referring to FIG. 1, since the external power supply 1 is shared by the VDD1-VSS1 power supply network and the VDD2-VSS2 power supply network, VDD1 and VDD2 have the same voltage level, and VSS1 and VSS2 also have the same voltage level.

For example, VDD1 is a power supply voltage (VDDQ) dedicated to an output driver, and VDD2 is a general-purpose power supply voltage (VDD). VSS1 is a ground voltage (VSSQ) dedicated to the output driver, and VSS2 is a general-purpose ground voltage (VSS).

In this case, the VDD1-VSS1 power supply network 3 includes circuits configured to be operated with the power supply voltage (VDDQ) and the ground voltage (VSSQ) dedicated for the output driver such as a pre-driver and a main driver. The VDD2-VSS2 power supply network 4 includes circuits configured to be operated with the general-purpose power supply voltage VDD and the general-purpose ground voltage VSS, such as peripheral circuits of a semiconductor memory device.

As illustrated in FIG. 1, VSS1 (VSSQ) and VSS2 (general-purpose VSS) are mutually connected to each other through the metal interconnection 5. Thus, the power mesh for VSS1 (VSSQ) and the power mesh for VSS2 (general-purpose VSS) are mutually connected to each other.

In this embodiment, when different types of power supply networks are present, they may be mutually connected to each other through a shared metal interconnection when their DC voltage levels are the same. For example, VDD1 and VDD2 may be mutually connected to each other in some cases.

In such a structure, the different power supply networks may share a metal interconnection together within the semiconductor integrated circuit, thereby reducing the resistance thereof. Thus, noise in power caused by current flowing through such a metal interconnection may be reduced due to the reduced resistance. Moreover, such a metal interconnection has an effect on sharing a package interconnection, and thus, reduction in inductance accompanying the package interconnection is achieved, thereby contributing to improvement in quality of input/output signals.

In accordance with the exemplary embodiment of the present invention, different power meshes for separately supplying supply voltages for different usages even if they have the same DC level are mutually connected to each other through a shared metal interconnection. Thus, the package interconnection (that is, a metal interconnection) may be shared. The voltage drops (“IR drop”) across the metal interconnections constituting the power distribution network of the semiconductor integrated circuit may be reduced, and the package inductance caused by the metal interconnections may also be reduced. Therefore, a stable power supply level may be maintained, and the signal quality of the semiconductor integrated circuit may be improved through reduction of switching noise.

While the present invention has been described with respect to the specific embodiments, it will be apparent to those skilled in the art that various changes and modifications may be made without departing from the spirit and scope of the invention as defined in the following claims.

While the exemplary embodiments of the invention have been described in connection with the power meshes for supplying the typical ground voltage (general-purpose VSS) and the ground voltage (VSSQ) dedicated to the output driver are mutually connected to each other, the present invention can also be applied to the mutual connection of the power meshes to each other for supplying the power supply voltages or the ground voltages of a same DC level but for different usage types than the exemplary embodiments such as the typical power supply voltage (general-purpose VDD) or ground voltage (general-purpose VSS) and the power supply voltage (VDDL) or ground voltage (VSSDL) dedicated to the DLL.

What is claimed is:

1. A semiconductor integrated circuit, comprising:
a first power mesh configured to supply a first power to a first internal circuit;
a second power mesh configured to supply a second power to a second internal circuit, the first power and the second power being used for different purposes and being equal in DC level; and
a connection unit configured to connect the first power mesh to the second power mesh.

2. The semiconductor integrated circuit of claim 1, wherein the connection unit includes a metal interconnection configured to connect the first power mesh to the second power mesh.

3. A semiconductor integrated circuit, comprising:
a first power mesh configured to supply a first external power voltage to a first internal circuit; and
a second power mesh configured to supply a second external power supply voltage to a second internal circuit,
wherein the first external power supply voltage and the second external power supply voltage are used for different purposes and are equal in DC level, and the first power mesh and the second power mesh are electrically connected to each other.

4. The semiconductor integrated circuit of claim 3, wherein the first external power supply voltage includes a general-purpose power supply voltage, and the second external power supply voltage includes a power supply voltage dedicated to an output driver.

5. The semiconductor integrated circuit of claim 3, wherein the first external power supply voltage includes a general-purpose power supply voltage, and the second external power supply voltage includes a power supply voltage dedicated to a delay locked loop (DLL).

6. A semiconductor integrated circuit, comprising:
a first power mesh configured to supply a first ground voltage to a first internal circuit; and
a second power mesh configured to supply a second ground voltage to a second internal circuit,
wherein the first ground voltage and the second ground voltage are used for different purposes, and the first power mesh and the second power mesh are electrically connected to each other.

7. The semiconductor integrated circuit of claim 6, wherein the first ground voltage includes a general-purpose ground voltage and the second ground voltage includes a ground voltage dedicated to an output driver.

8. The semiconductor integrated circuit of claim 6, wherein the first ground voltage includes a general-purpose ground voltage and the second ground voltage includes a ground voltage dedicated to a delay locked loop (DLL).
